(19) United States
(12) Patent Application Publication
(10) Pub. No.: US 2026/0119440 A1
(43) Pub. Date: Apr. 30, 2026

(54) COMPUTATIONAL STORAGE DEVICE AND COMPUTATIONAL STORAGE SYSTEM INCLUDING THE SAME

(71) Applicant: SAMSUNG ELECTRONICS CO., LTD., Suwon-si (KR)

(72) Inventors: Myoungsoo JUNG, Daejeon (KR); Seungkwan Kang, Daejeon (KR); Hyungseok Ko, Daejeon (KR); Heemin Kim, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/327,145

(22) Filed: Sep. 12, 2025

(30) Foreign Application Priority Data
Oct. 28, 2024 (KR) 10-2024-0149086

(51) Int. Cl. G06F 13/42; G06F 8/41; G06F 12/02; G06F 12/14; G06F 17/16

(52) U.S. Cl. CPC G06F 13/4221; G06F 8/433; G06F 12/0292; G06F 12/1433; G06F 17/16; G06F 2213/0026

(57) ABSTRACT

A computational storage device may include: a memory array including: a first area; and a second area; a memory controller configured to access the first area and have limited access to the second area; a hardware accelerator configured to access the second area; a first interface block configured to connect the memory controller to a host processor; and a second interface block configured to connect the hardware accelerator to the host processor. The memory controller may be further configured to perform a first type of request of the host processor, for data of the first area, and the hardware accelerator may be configured to perform a second type of request in connection with a tensor of the host processor, for data of the second area.

### CROSS-REFERENCE TO RELATED APPLICATION

This application claims priority to Korean Patent Application No. 10-2024-0149086, filed on Oct. 28, 2024, in the Korean Intellectual Property Office, the disclosure of which is incorporated by reference herein in its entirety.

### BACKGROUND

### 1. Technical Field

The present disclosure relates to a computational storage device and a computational storage system.

### 2. Description of Related Art

Recently, attempts to improve processing speed by coupling accelerators with computational storage devices have been made. Such attempts have been made in various fields, and, in particular, research has been conducted on a computational storage device where an accelerator is coupled with a large-capacity storage device such as a solid state drive (SSD) to process computations.

When there is a gap between the data processing performance of an accelerator of a computational storage device and a memory inside the computational storage device, the efficiency of the computational storage device in processing computations may decrease.

### SUMMARY

The present disclosure provides a computational storage device and a computational storage system.

According to an aspect of the disclosure, a computational storage device, may include: a memory array including: a first area; and a second area; a memory controller configured to access the first area and have limited access to the second area; a hardware accelerator configured to access the second area; a first interface block configured to connect the memory controller to a host processor; and a second interface block configured to connect the hardware accelerator to the host processor. The memory controller may be further configured to perform a first type of request of the host processor, for data of the first area, and the hardware accelerator may be configured to perform a second type of request in connection with a tensor of the host processor, for data of the second area.

According to an aspect of the disclosure, a computational storage system, may include: a host processor; a host memory operatively connected to the host processor; and a computational storage device configured to communicate with the host processor and generate output at a request of the host processor, wherein the computational storage device includes: a memory array including: a first area; and a second area; a memory controller configured to access the first area and have limited access to the second area; a hardware accelerator configured to access the second area; a first interface block configured to connect the memory controller to the host processor; and a second interface block configured to connect the hardware accelerator to the host processor. The memory controller may be further configured to perform a first type of request of the host processor for data of the first area, and the hardware accelerator may be configured to perform a second type of request in connection with a tensor of the host processor for data of the second area.

According to an aspect of the disclosure, a computational storage device may include: a memory array including: a first area; and a second area; a memory controller configured to access the first area; a hardware accelerator configured to access the second area;

a first interface block configured to connect the memory controller to a host processor; and a second interface block configured to connect the hardware accelerator to the host processor. The memory controller may be configured to perform a first type of request of the host processor for data of the first area, the hardware accelerator may be configured to perform a second type of request in connection with a tensor of the host processor for data of the second area, the first type of request may include at least one of a user data read request and a user data write request for the first area, which the memory controller is configured to perform, the second type of request may include at least one of a request for registration of a program and a request for execution of the program for data of the second area, the program may include a data flow graph including at least one of a tensor read request, a tensor write request, and a tensor operation request for kernels, the memory controller, the hardware accelerator, the memory array, the first interface block, and the second interface block may be configured to communicate based on a first protocol, and the first interface block and the second interface block may be configured to communicate with the host processor based on a second protocol different from the first protocol.

According to one or more embodiments of the present disclosure, a tensor operation process may be optimized so that a high-bandwidth computational task by the accelerator may be effectively supported. As a result, it may be possible to overcome the gap caused by the difference between the speed at which the memory array transmits data and the speed at which the accelerator processes data.

According to one or more embodiments of the present disclosure, the accelerator may perform operations related to each node of a data flow graph in a program by referring to the data flow graph. Accordingly, it may be possible to load data related to nodes required for an operation into the accelerator core in advance of performing the operation to improve the efficiency of the operation process and minimize overhead, bottlenecks, etc. due to idle time.

According to example embodiments of the present disclosure, the various advantages and effects of the present disclosure are not limited to the foregoing, and would be more easily understood through the description of specific embodiments of the present disclosure.

### BRIEF DESCRIPTION OF THE DRAWINGS

Embodiments will be more clearly understood from the following detailed description taken in conjunction with the accompanying drawings in which:

FIG. 1 illustrates a computational storage system according to one or more embodiments of the present disclosure;

FIG. 2 is a view for illustrating details of the computational storage system according to one or more embodiments of the present disclosure;

FIG. 3 is a view for showing the internal components of a computational storage device according to one or more embodiments of the present disclosure;

FIG. 4 is a view for illustrating the internal components of an accelerator according to one or more embodiments of the present disclosure;

FIG. 5 illustrates an example of how the computational storage device operates in response to a request from a host processor according to one or more embodiments of the present disclosure;

FIG. 6A illustrates an example of how a program registration request is performed according to one or more embodiments of the present disclosure;

FIG. 6B shows an example of how a program execution request is performed according to one or more embodiments of the present disclosure;

FIG. 7 shows a data flow graph according to one or more embodiments of the present disclosure;

FIG. 8 illustrates an example of how a tensor save request is performed for a second area of a memory array according to one or more embodiments of the present disclosure;

FIG. 9 illustrates an example of how a tensor read request is performed for the second area of the memory array according to one or more embodiments of the present disclosure;

FIG. 10A illustrates an example of how the tensor read request is performed for a first area of the memory array according to one or more embodiments of the present disclosure;

FIG. 10B illustrates an example of how the tensor read request is performed for a first area of the memory array according to one or more embodiments of the present disclosure;

FIG. 11 illustrates an example of how an accelerator memory manager performs a tensor operation according to one or more embodiments of the present disclosure;

FIG. 12 shows an example of how prefetching is performed according to one or more embodiments of the present disclosure;

FIG. 13 shows an example of how tiling is performed according to one or more embodiments of the present disclosure;

FIG. 14 illustrates an example of how a tensor save request for performing a tile-based operation is carried out according to one or more embodiments of the present disclosure;

FIG. 15A shows an example of how tensor operation requests are performed on tile-by-tile according to one or more embodiments of the present disclosure; and

FIG. 15B shows an example of how tensor operation requests are performed tile-by-tile according to one or more embodiments of the present disclosure.

### DETAILED DESCRIPTION

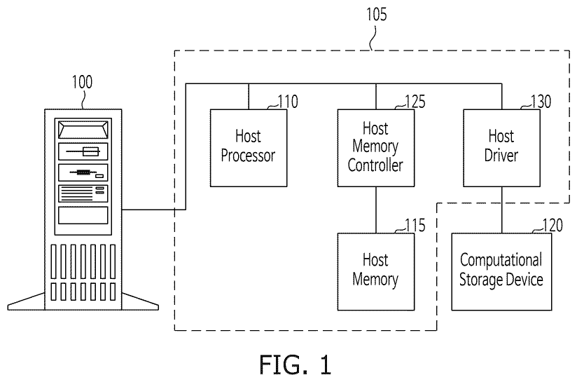

Hereinafter, one or more embodiments of the present disclosure will be described with reference to FIGS. 1 to 15B. The same reference numerals may refer to the same components throughout the present disclosure.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

FIG. 1 illustrates a computational storage system 100 according to one or more embodiments of the present disclosure. As illustrated, the computational storage system 100 may include a host 105 and a computational storage device 120. For convenience of description, FIG. 1 shows the host 105 and the computational storage device 120 placed outside the computational storage system 100, but the host 105 and the computational storage device 120 may also be positioned inside the computational storage system 100.

The host 105 may include a host processor 110 and a host memory 115. The host processor 110 may control the overall operation of the host 105. For example, the host processor 110 may be implemented with at least one of various processing units including a central processing unit (CPU), an application processor (AP), a graphics processing unit (GPU), a neural processing unit (NPU), a field-programmable gate array (FPGA), and a microprocessor. In addition, the host processor 110 may be implemented with a system-on-a-chip (SoC).

The host processor 110 may include a single processor or any number of processors. The host processor 110 may include a reduced instruction set computer (RISC) architecture, a complex instruction set computer (CISC) architecture, or a combination thereof. In addition, the host processor 110 may be a single core processor or a multi-core processor.

The host processor 110 may be operatively connected to the host memory 115. The host memory 115 may store data, commands, or programs necessary for the operation of the host processor 110. In one or more embodiments, the host memory 115 may be used to store short-term data. Here, the short-term data may refer to data that is not expected to be stored for a long period of time. For a specific example, the short-term data may include temporary files, cache, etc.

The host processor 110 and host memory 115 may support an operating system in which various applications can be executed. The applications may issue a read request or a write request to the host memory 115. A host memory controller 125 may manage the transfer of data between the host processor 110 and the host memory 115 based on requests issued by the applications.

The host processor 110 may communicate with the computational storage device 120 through a host driver 130. The host 105/the host processor 110 and the computational storage device 120 may communicate with each other based on the Peripheral Component Interconnect Express (PCIe) protocol, but the present disclosure is not limited thereto. For example, the host processor 110 may communicate with the computational storage device 120 based on a range of protocols, such as Non-Volatile Memory Express (NVMe), NVMe over Fabrics (NVMe-oF), Remote Direct Memory Access (RDMA), Transmission Control Protocol/Internet Protocol (TCP/IP), Universal Flash Storage (UFS), embedded MultiMediaCard (eMMC), InfiniBand, Serial Attached Small Computer System Interface (SCSI), Internet SCSI (iSCSI), and Serial AT Attachment (SATA).

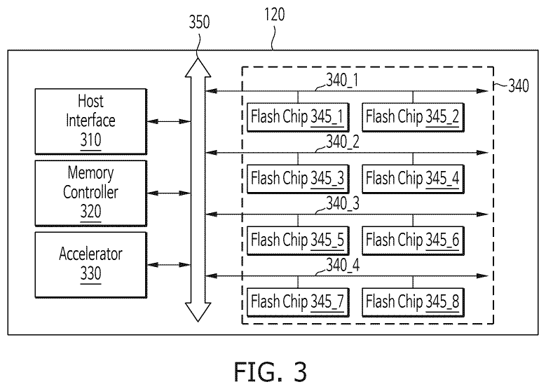

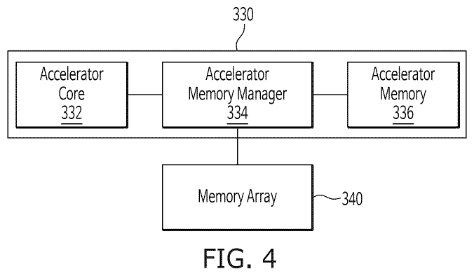

The computational storage device 120 may be a device that performs computational operations and data storage operations. FIG. 1 shows the computational storage system 100 including a single computational storage device 120, but the present disclosure is not limited thereto. The computational storage system 100 may include a plurality of computational storage devices. The computational storage device 120 may include a solid state drive (SSD), a hard disk drive (HDD), a solid state hybrid drive (SSHD), etc. The internal components of the computational storage device 120 will be described in detail below with reference to FIGS. 3 and 4.

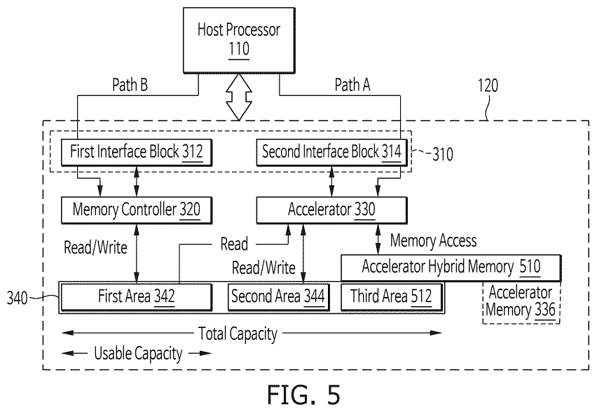

The computational storage device 120 may generate output for a request sent by the host processor 110. For example, the computational storage device 120 may read data stored therein in response to a read request sent by the host processor. In addition, the computational storage device 120 may store data therein in response to a write request sent by the host processor. Furthermore, the computational storage device 120 may perform a computational operation in response to a computational request sent by the host processor. An example of how the computational storage device 120 operates in response to a request sent by the host processor 110 will be described in detail with reference to FIG. 5.

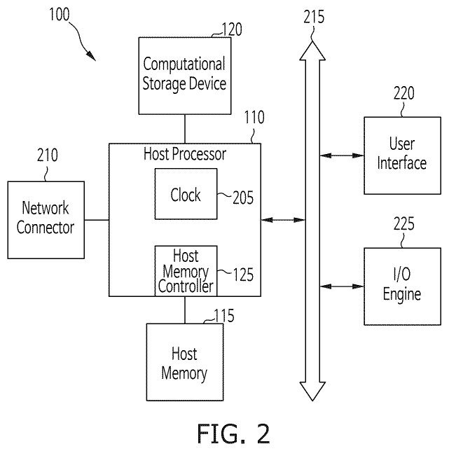

FIG. 2 is a view for illustrating details of the host processor 110 of the computational storage system 100 according to one or more embodiments of the present disclosure. As illustrated, the computational storage system 100 may include the host processor 110. The host processor 110 may control the overall operation of the computational storage system 100.

The host processor 110 may include the host memory controller 125 and a clock 205. The host memory controller 125 may manage the transfer of data between the host processor 110 and the host memory 115. The clock 205 may synchronize the operations of the host processor 110 and the host memory 115.

The host processor 110 may be connected to the host memory 115. The host memory 115 may be a volatile memory, a non-volatile memory, or a combination thereof. For example, the host memory 115 may include a volatile memory such as a dynamic random-access memory (DRAM), and a static random-access memory (SRAM) and/or a non-volatile memory such as an electrically erasable programmable read-only memory (EEPROM), a ferroelectric random-access memory (FRAM), a phase-change random-access memory (PRAM), a magneto-resistive random-access memory (MRAM), and a flash memory.

The host processor 110 may be connected to the computational storage device 120. The host processor 110 may transmit data to the computational storage device 120 and receive it therefrom. For example, the host processor 110 may transmit a request to the computational storage device 120 to cause the computational storage device 120 to perform a specific operation. The computational storage device 120 may carry out an operation of a request received from the host processor 110 in response to the request, and may return data generated as a result of performing the operation to the host processor 110 in response to the request.

The host processor 110 may be connected to a network connector 210. The host processor 110 may be connected to an external network through the network connector 210. The network connector 210 may be implemented as an Ethernet connector, a wireless connector, etc., but the present disclosure is not limited thereto.

The host processor 110 may be connected to a user interface 220 and an I/O engine 225 through a bus 215. The host processor 110 may receive input data from the user interface 220 through the bus 215 and generate output data for the received input data. For example, the host processor 110 may receive a user query from the user interface 220. For example, the host processor 110 may receive a user query in text form. In one example, the user query may be in the form of a question, a request to perform a specific task, or a request for information, but the present disclosure is not limited thereto.

The host processor 110 may analyze a user query based on a language model, e.g., LLM, loaded into the host memory 115, etc., thereby generating a response to the user query. The host processor 110 may output the generated response through the user interface 220.

In addition, based on a user query, the host processor 110 may extract a context or subset of the user query from a corpus stored in an external database and/or the computational storage device 120, and may input the extracted context or subset and the user query as one prompt into a language model. That is, the host processor 110 may create a response from a language model by using not only a user query but also external information in connection with the user query. As a result, the quality of the language model's response may be improved, and hallucination of the language model may be reduced.

The I/O engine 225 may support the process of inputting or outputting data through the bus 215. For example, the I/O engine 225 may reduce overhead, bottlenecks, etc. of the host processor 110 that may occur as the host processor 110 directly controls the work of inputting or outputting data.

FIG. 3 is a view for showing the internal components of the computational storage device 120 according to one or more embodiments of the present disclosure. As illustrated, the computational storage device 120 may include a host interface 310, a memory controller 320, an accelerator 330, and a memory array 340.

The host interface 310 may connect a host processor, such as the host processor 110 in FIG. 1, and the memory controller 320. In addition, the host interface 310 may connect the host processor and the accelerator 330. For example, the host interface 310 may include a first interface block and a second interface block, and the host processor may be connected to the memory controller 320 through the first interface block while it may be connected to the accelerator 330 through the second interface block. This will be described in detail below with reference to FIG. 5. The host interface 310 may transmit requests sent by a host processor to each of the memory controller 320 and the accelerator 330.

The memory controller 320 and the accelerator 330 may access the memory array 340. For example, each of the memory controller 320 and the accelerator 330 may perform a read operation and/or a write operation on the memory array 340 based on a request sent by a host processor, thereby transmitting data to the memory array 340 or receiving it therefrom. Here, the memory controller 320 and the accelerator 330 may perform requests from a host processor for different areas of the memory array 340. In addition, the memory controller 320 may have limited access to a specific area of the memory array 340. Accordingly, the host may also have limited direct access to a specific area of the memory array 340. A specific example thereof will be described in detail with reference to FIG. 5.

The memory array 340 may include a non-volatile memory. For example, the memory array 340 may include an NAND flash memory, and may be implemented in various forms of a 2D NAND memory array, a vertical NAND (VNAND) memory array, etc. However, the type of a memory included in the memory array 340 is not limited thereto, and the memory array 340 may include various types of non-volatile memories such as an electrically erasable programmable read-only memory (EEPROM), a ferroelectric random-access memory (FRAM), a phase-change random-access memory (PRAM), and a magneto-resistive random-access memory (MRAM).

The memory array 340 may include a plurality of flash chips 345_1 to 345_8. Each of the plurality of flash chips 345_1 to 345_8 may be implemented as an arbitrary memory unit that can operate according to an individual request of the memory controller 320. FIG. 3 shows the memory array 340 implemented with the flash chips 345_1 to 345_8, but the present disclosure is not limited thereto. The memory array 340 may be implemented in various forms of a die, a package, etc.

Each of the plurality of flash chips 345_1 to 345_8 may be connected to one of a plurality of channels 340_1 to 340_4. For example, each of the flash chips 345_1 and 345_2 may be connected to a first channel 340_1, and each of the flash chips 345_3 and 345_4 may be connected to a second channel 340_2. In FIG. 3, the memory array 340 includes eight flash chips 345_1 to 345_8 connected through four channels 340_1 to 340_4, but the present disclosure is not limited thereto. The memory array 340 may include any number of flash memory chips connected through any number of channels.

Each of the memory controller 320 and the accelerator 330 may transmit data to the memory array 340 or receive it therefrom through the plurality of channels 340_1 to 340_4. For example, the memory controller 320 may transmit data to the memory array 340 or receive it therefrom through at least some of the plurality of channels 340_1 to 340_4. Similarly, the accelerator 330 may transmit data to the memory array 340 or receive it therefrom through at least some of the plurality of channels 340_1 to 340 4.

Each of the memory controller 320 and the accelerator 330 may transmit data to the memory array 340 or receive it therefrom in parallel through the plurality of channels. For example, the memory controller 320 may transmit or receive data through the first channel 340_1 while transmitting or receiving data through the second channel 340_2. For another example, the accelerator 330 may transmit or receive data through a third channel 340 3 while transmitting or receiving data through a fourth channel 340_4. For still another example, while the memory controller 320 may transmit or receive data through the first channel 340_1, the accelerator 330 may transmit or receive data through the second channel 340 2.

The host interface 310, the memory controller 320, the accelerator 330, and the memory array 340 may be connected to each other and communicate with each other through the bus 350. Here, the protocol used for communication of the bus 350 may be different from the protocol used for communication between a host, e.g., the host 105 in FIG. 1, and the computational storage device 120. For example, the average communication speed based on the protocol used for communication of the bus 350 may be higher than the average communication speed based on the protocol used for communication between the host and the computational storage device 120. For a specific example, the host interface 310, the memory controller 320, the accelerator 330, and the memory array 340 may communicate with each other based on the Advanced extensible Interface (AXI) protocol, and the host and the computational storage device 120 may communicate with each other based on the PCIe protocol.

FIG. 4 is a view for illustrating the internal components of the accelerator 330 according to one or more embodiments of the present disclosure. The accelerator 330 may refer to a hardware accelerator. The accelerator 330 may be implemented in various forms of a graphics processing unit (GPU), a field-programmable gate array (FPGA), a tensor processing unit (TPU), an application-specific integrated circuit (ASIC), a neural processing unit (NPU), a general-purpose graphics processing unit (GPGPU), etc.

The accelerator 330 may include an accelerator core 332, an accelerator memory manager 334, and an accelerator memory 336.

The accelerator core 332 may perform an operation of a request sent by a host processor, e.g., the host processor 110 in FIG. 1. For example, the host processor may send a request to the accelerator 330 to register or execute a program that includes a data flow graph (DFG). The accelerator core 332 may carry out operations on data in connection with the request to execute the program.

In FIG. 4, the accelerator 330 includes a single accelerator core 332, but the present disclosure is not limited thereto. For example, the accelerator 330 may include any number of accelerator cores, and the multiple accelerator cores may perform tasks in parallel.

The accelerator memory manager 334 may process a request for registration of a program from the host processor. In addition, based on a data flow graph included in the program, the accelerator memory manager 334 may perform a read or write request for data such as a tensor required for an operation. Here, the tensor may refer to a multidimensional array. For example, the tensor may include a scalar (0-dimensional), a vector (1-dimensional), a matrix (2-dimensional), etc.

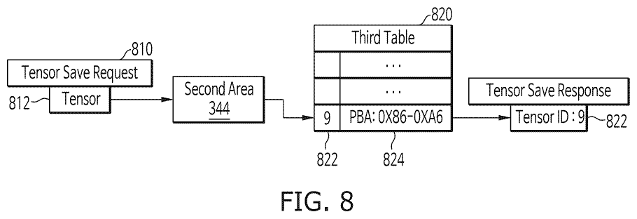

The accelerator memory 336 may store data such as a tensor for the accelerator core 332 to perform operations. It will be described in detail with reference to FIGS. 8 to 10B how operations are performed by the accelerator core 332, the accelerator memory manager 334, and the accelerator memory 336.

The accelerator memory manager 334 may communicate with the memory array 340. The accelerator memory manager 334 may be connected to the memory array 340, so as to load data such as a tensor required for operations into the accelerator memory 336 or store data stored in the accelerator memory 336 and/or data generated by the accelerator core 332 into the memory array 340.

In one or more embodiments, the accelerator memory 336 may be a volatile memory, and the memory array 340 may be a non-volatile memory. Specifically, the accelerator memory 336 may be a DRAM while the memory array 340 may be an NAND flash memory, but the present disclosure is not limited thereto. The accelerator memory 336 may be used when it is necessary to access data at a high speed within the accelerator 330. For example, it may be used to temporarily store frequently referenced data, an intermediate value of calculation, etc. while the accelerator 330 is processing an operation. On the other hand, the memory array 340 may be used to store a relatively large amount of data. That is, data frequently used in the accelerator 330, e.g., model weights, may be cached in the accelerator memory 336 while data that does not need to be processed in real time, e.g., preprocessing data of a corpus, may be stored in the memory array 340, so that the performance of a computational storage system, such as the computational storage system 100 in FIG. 1, may be improved and a structure for efficiently storing data may be provided.

In other embodiments, the accelerator memory 336 may be a byte addressable memory for reading and writing data by specifying an address in units of bytes, and the memory array 340 may be a page addressable memory for reading and writing data in units of pages.

FIG. 5 illustrates an example of how the computational storage device 120 operates in response to a request from the host processor 110 according to one or more embodiments of the present disclosure. The computational storage device 120 may include the host interface 310, the memory controller 320, the accelerator 330, and the memory array 340.

The host interface 310 may include a first interface block 312 and a second interface block 314. The host interface 310 may be implemented as circuitry, and the first interface block 312 and the second interface block 314 may be implemented as separate circuits or an integrated circuit. In one or more embodiments, the first interface block 312 and the second interface block 314 may be implemented with different chips within the host interface 310. In another embodiment, the first interface block 312 and the second interface block 314 may be implemented through different types of firmware for a single chip within the host interface 310.

The host processor 110 may communicate with the memory controller 320 and the accelerator 330 through the host interface 310. For example, the host processor 110 may communicate with the memory controller 320 through the first interface block 312 and with the accelerator 330 through the second interface block 314. A host driver, such as the host driver 130 in FIG. 1, that supports communication between the host processor 110 and the host interface 310 may include a driver stack for communicating with the memory controller 320 through the first interface block 312 and a driver stack for communicating with the accelerator 330 through the second interface block 314.

The first interface block 312 may transmit a request from the host processor 110 to the memory controller 320. The memory controller 320 may access the memory array 340 to perform the received request. The second interface block 314 may transmit a request from the host processor 110 to the accelerator 330. The accelerator 330 may access the memory array 340 to perform the request from the host processor 110.

The memory array 340 may include a storage space divided into a plurality of areas. Each of the plurality of areas may also be referred to as a “namespace,” and data stored in each of the plurality of areas may be stored in a form optimized for a corresponding namespace.

The plurality of areas of the memory array 340 may include a first area 342 where direct access of the host processor 110 is permitted and a second area 344 where direct access of the host processor 110 is restricted. That is, the first area 342 may be a storage space in connection with a usable capacity disclosed to a host among a total capacity of the memory array 340. The second area 344 may be a storage space that is not disclosed to the host, and may refer to a storage space for performing its own operation for a specific request, e.g., a tensor-related request, from the host processor 110.

The memory controller 320 may carry out a first type of request of the host processor 110, which has been received through the first interface block 312. Here, the first type of request may be a request for data of the first area 342 of the memory array 340. The memory controller 320 may receive and process a data write request such as a user data write request to store data such as user data in the first area 342. For example, the memory controller 320 may store specific data in the first area 342 and assign a logical address to the specific data in response to a data write request from the host processor 110. In addition, the memory controller 320 may store and manage corresponding information on a physical address and a logical address where specific data is stored in the first area 342.

Furthermore, the memory controller 320 may receive and process a data read request, e.g., a user data read request, for loading data, such as user data, stored in the first area 342. For example, a read request for data stored in the first area 342 may include a logical address for a specific data to be loaded. In this case, the memory controller 320 may obtain a physical address for the first area 342 of the specific data corresponding to the logical address of the specific data. As a result, the specific data stored in the first area 342 may be loaded into the memory controller 320. The loaded specific data may be returned to the host processor 110 by the memory controller 320.

The accelerator 330 can perform a second type of request of the host processor 110, which has been received through the second interface block 314. Here, the second type of request may be a request for data of the second area 344 of the memory array 340. In addition, the second type of request may be a request for the registration or execution of a program containing a data flow graph (DFG). The accelerator 330 may carry out a request for data of the second area 344 by providing an application binary interface (ABI) in connection with the execution of programs.

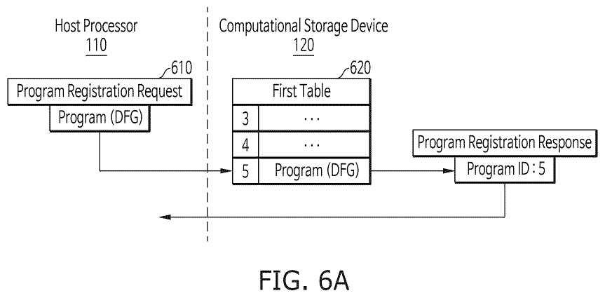

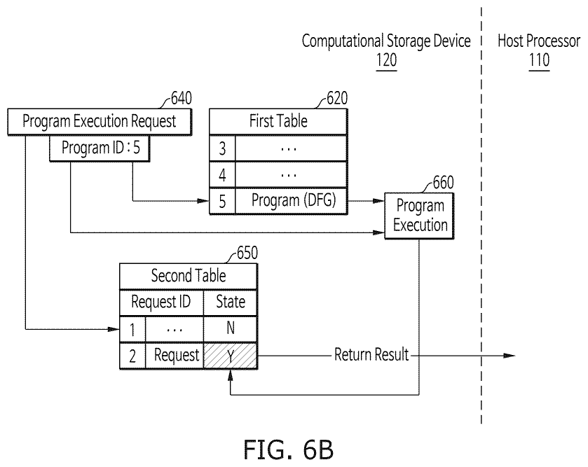

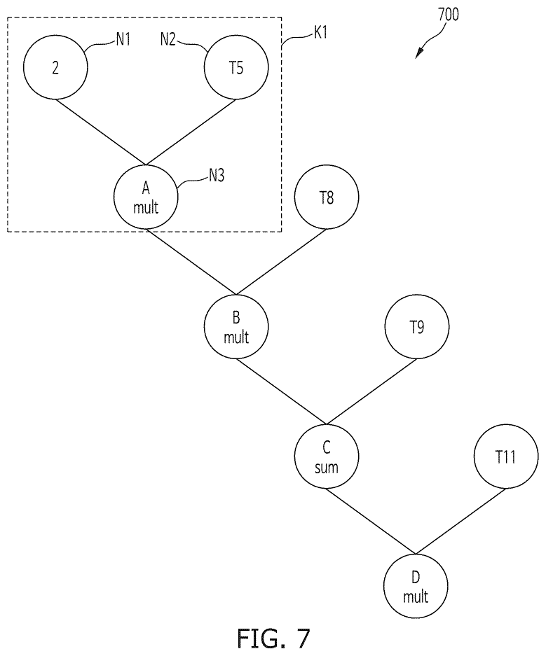

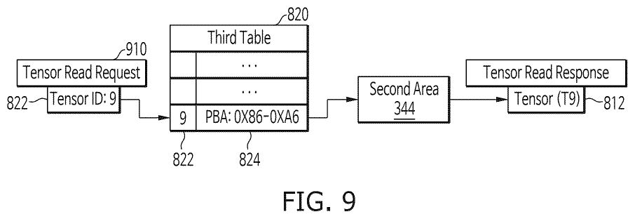

For a specific example, the accelerator 330 may perform a tensor save request to store a tensor generated in the process of executing a program in the second area 344. In addition, the accelerator 330 may carry out a tensor read request to load a tensor required for executing a program from the second area 344. In other embodiments, when a tensor required for executing a program is stored in the first area 342, the accelerator 330 may perform a tensor read request to load a corresponding data from the first area 342. A tensor loaded from the first area 342 may be stored back in the second area 344 if necessary. An example of how a request to execute a program and a request to register the program are performed will be described in detail with reference to FIGS. 6 and 7. In addition, an example of how a tensor save request or a tensor read request for a tensor generated in the process of executing a program is carried out will be described in detail with reference to FIGS. 9 to 12.

In one or more embodiments, the memory array 340 may further include a third area 512. The third area 512 may be designated as a swap space for the accelerator 330. That is, the third area 512 may serve as a spare space used when the capacity of the accelerator memory 336 is insufficient. The accelerator memory 336 of the accelerator 330 and the third area 512 of the memory array 340 may be used as an accelerator hybrid memory 510. An accelerator memory manager, such as the accelerator memory manager 334 in FIG. 4, of the accelerator 330 may access the accelerator memory 336 or the third area 512 to perform a read request or a write request for a tensor related to the execution of a program.

The host processor 110 may determine the size of a storage space to be used for each area at the time of defining the first area 342, the second area 344, and the third area 512 of the memory array 340. The host processor 110 may determine the size of the storage space of each of the first area 342, the second area 344, and the third area 512, based on the ratio of the capacity of data accessed by the memory controller 320 and the capacity of data used by the accelerator 330 to perform operations.

FIG. 6A illustrates an example of how a program registration request 610 is performed according to one or more embodiments of the present disclosure. The host processor 110 may transmit the program registration request 610 to the computational storage device 120. In one or more embodiments, a program may refer to a subset of data needed to perform a series of tasks or operations to be executed on an accelerator. In addition, the program may include a data flow graph containing one or more kernels. A specific example of a data flow graph will be described in detail with reference to FIG. 7.

The host processor 110 may transmit the program registration request 610 to a second interface block, e.g., the second interface block 314 in FIG. 5, of the computational storage device 120. The second interface block may assign a program identifier (ID), e.g., Program ID: 5, to a program in response to the receipt of the program registration request 610. In addition, the second interface block may return the assigned program ID to the host processor 110 along with a program registration response 630. A program registered by the host processor 110 may be stored in an accelerator memory, an accelerator memory manager, a second area of a memory array, etc., but the present disclosure is not limited thereto.

A program ID assigned to a program may be stored in a first table 620. The first table 620 may refer to a lookup table for referring to the program ID assigned to the program. The first table 620 may store corresponding information on the program and the program ID assigned thereto.

The first table 620 may be stored in a storage accessible to a second interface block. For example, the first table 620 may be stored in a memory connected to a chip with which the second interface block is implemented, but the present disclosure is not limited thereto.

FIG. 6B shows an example of how a program execution request 640 is performed according to one or more embodiments of the present disclosure. The host processor 110 may transmit the program execution request 640 to the computational storage device 120. The host processor 110 may transmit the program execution request 640 to a second interface block, e.g., the second interface block 314 in FIG. 5, of the computational storage device 120. The program execution request 640 may include a program ID assigned to a program to be executed. In addition, the program execution request 640 may further include additional data or information related to the execution of the program.

The second interface block may, in response to receiving the program execution request 640, assign a request ID to the program execution request 640. The request ID assigned to the program execution request 640 may be stored in a second table 650. The second table 650 may refer to an execution management table for managing at least one program execution request received through the second interface block and referring to a request ID assigned to each of the program execution requests. The second table 650 may store corresponding information on the program execution request 640 and a request ID assigned to the program execution request 640. In addition, status information, e.g., Y or N, for checking how the program execution request 640 is performed may be stored in the second table 650.

The second interface block may receive the program execution request 640 and identify a program to be executed by the program execution request 640. For example, the second interface block may identify a program corresponding to a program ID included in the program execution request 640 by referring to the first table. Then, the second interface block may transmit the program to an accelerator, e.g., the accelerator 330 in FIG. 5. In other embodiments, the second interface block may transmit data/information that enables the accelerator, e.g., the accelerator 330 in FIG. 5., to load the program. The accelerator may execute the program based on a data flow graph included in the program and return the result of performing the program execution request 640 to the host processor 110.

The second table 650 may be updated as the program execution request 640 is completely executed. For example, the second interface block may update the status information of a corresponding program execution request from “N” to “Y” when a program that was expected to be executed upon the request has been fully executed. The updated status information may be returned to the host processor 110 along with the result of performing the program execution request 640, but the present disclosure is not limited thereto.

The second table 650 may be stored in a storage accessible to the second interface block. For example, the second table 650 may be stored in a memory connected to a chip with which the second interface block is implemented, but the present disclosure is not limited thereto.

In one or more embodiments, a host may specify a return mechanism for a program execution result resulting from a program execution 660 based on the format of the program execution result. For example, when the size of the program execution result has been determined before the program is executed, the host may designate a host memory area in advance to receive the program execution result. For example, the host may assign an address to the host memory area to receive a response to a program execution request, and may receive the program execution result at the assigned address. In this case, a computational storage device, e.g., a second interface block, may record the program execution result at the address allocated to the host memory area through a direct memory access, and may transmit an interrupt to the host to notify the completion of the execution of the program.

In contrast, when the size of the program execution result cannot be predicted before the execution of the program, or when the size of the program execution result is variable, the computational storage device, e.g., the second interface block, may transmit an interrupt to the host after the execution of the program has been completed. Thereafter, the computational storage device may divide the program execution result into multiple pieces, e.g., N pieces, of data of a size that can be read by the host, and the host may obtain the first piece of data. Here, the first piece of data may include the length of data of the program execution result. Data to be repeatedly read by the host may be stored in a location predetermined in a protocol, such as a mailbox register within the second interface block. Then, based on the length of the data of the program execution result, which the first piece of data contains, the host may obtain the program execution result by repeatedly obtaining the data at the predetermined location. Accordingly, when the size of a program execution result has not been determined, it may be possible to efficiently transmit the program execution result even without designating a host memory area in advance.

FIG. 7 shows a data flow graph 700 according to one or more embodiments of the present disclosure. In one or more embodiments, a program may include the data flow graph 700. The data flow graph 700 may refer to an acyclic, unidirectional computation graph including at least one kernel connecting multiple nodes.

In one or more embodiments, a kernel may mean a basic unit of computation. The kernel may receive as input data stored in a memory array, data included in a program itself, parameter data required for the execution of a program at the time of executing the program, output data generated as a result of a preceding operation, etc., and may perform operations thereon. Data used for the operations may include various types of data, such as tensors, vectors, scalars, and matrices. For a specific example, a first kernel K1 may represent a flow of an operation in which the results of operations on data of each of a first node N1 and a second node N2 are output as a third node N3. In order to perform the operation by the first kernel K1, data of the first node N1 and data of the second node N2 may be required. That is, the first node N1 and the second node N2 may be dependent on the third node N3.

An accelerator may carry out operations of each node of the data flow graph 700 by referring to the data flow graph 700 included in a program. In addition, in order to make a computation process more efficient, data such as tensors in connection with nodes required for the computation may be loaded into an accelerator core before the computation is performed.

FIG. 8 illustrates an example of how a tensor save request 810 is performed for the second area 344 of a memory array according to one or more embodiments of the present disclosure. An accelerator may perform a program execution request, e.g., the program execution request 640 in FIG. 6B, from a host processor. The execution of a program may be carried out by an accelerator core of the accelerator. The accelerator core, such as the accelerator core 332 in FIG. 4, may execute the program based on a data flow graph of the program. An accelerator memory manager, e.g., the accelerator memory manager 334 in FIG. 4, may perform the tensor save request 810 to store a tensor generated during the execution of a program in the second area 344.

For example, the accelerator memory manager may store a specific tensor 812 in the second area 344 of the memory array and may assign a tensor ID 822, e.g., Tensor ID: 9, to the specific tensor 812. The assigned tensor ID 822 may be stored in a third table 820 together with a physical address 824 of the second area 344 where the specific tensor 812 is stored. Here, the third table 820 may refer to a translation table between the tensor ID 822 and the physical address 824 for referring to the tensor ID 822 assigned the specific tensor 812 and the physical address 824. The third table 820 may store corresponding information on the tensor ID 822 required for a read request for the specific tensor 812 and the physical address 824 of the second area 344 where the specific tensor 812 is stored.

The third table 820 may be stored in an internal storage of an accelerator memory manager, but the present disclosure is not limited thereto. The third table 820 may be stored in any storage accessible to the accelerator memory manager. For example, the third table 820 may be stored in an accelerator memory, e.g., the accelerator memory 336 in FIG. 4.

FIG. 9 illustrates an example of how a tensor read request 910 is performed for the second area 344 of a memory array according to one or more embodiments of the present disclosure. An accelerator may carry out a program execution request from a host processor. An accelerator memory manager may perform the tensor read request 910 for a tensor required to execute a program. For example, when the tensor required to execute the program is stored in the second area 344 of the memory array, the accelerator memory manager may load the tensor stored in the second area 344 into an accelerator memory.

The tensor read request 910 for the second area 344 may include the tensor ID 822, e.g., Tensor ID: 9, of the specific tensor 812 to be loaded into the accelerator memory. The accelerator memory manager may identify the physical address 824 for the second area 344 of the specific tensor 812 corresponding to the tensor ID 822 by referring to the third table 820. Thereafter, the accelerator memory manager may load the specific tensor 812 from the second area 344 into the accelerator memory based on the identified physical address 824.

In one or more embodiments, based on a data flow graph, the accelerator memory manager may plan the tensor read request 910 for a tensor required to execute a program. For example, the accelerator memory manager may minimize overhead, bottlenecks, etc. caused by idle time by preloading a tensor required for an operation subsequent to the current operation into the accelerator memory.

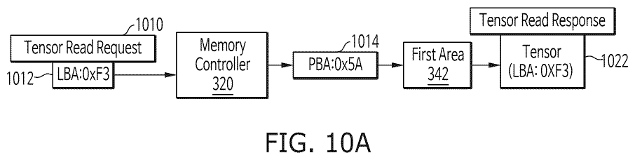

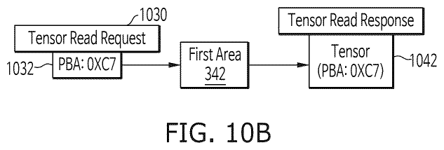

FIGS. 10A and 10B illustrate examples of how a tensor read request 1010 and 1030 is performed for the first area 342 of the memory array 340 according to one or more embodiments of the present disclosure. An accelerator may perform a program execution request from a host processor. Based on a data flow graph, an accelerator memory manager may perform the tensor read request 1010 and 1030 for a tensor required to execute a program. For example, when the tensor required to execute the program is stored in the first area 342 of the memory array, the accelerator memory manager may load the tensor stored in the first area 342 into an accelerator memory.

Referring to FIG. 10A, the tensor read request 1010 for the first area 342 may include a logical address 1012, e.g., LBA:0xF3, of a specific tensor 1022 to be loaded into the accelerator memory. In this case, the accelerator memory manager may obtain the specific tensor 1022 corresponding to the logical address 1012 from the first area 342 through the memory controller 320. For example, the accelerator memory manager may transmit the logical address 1012 to the memory controller 320, and the memory controller 320 may obtain a physical address 1014, e.g., PBA:0x5A, corresponding to the logical address 1012. Then, the memory controller 320 may obtain the specific tensor 1022 corresponding to the physical address 1014 from the first area 342 and provide it to the accelerator memory manager. That is, the accelerator memory manager may load the specific tensor 1022 stored in the first area 342 into the accelerator memory through the memory controller 320 in response to the tensor read request 1010 for the first area 342.

Referring to FIG. 10B, the tensor read request 1030 for the first area 342 may include a physical address 1032, e.g., PBA:0XC7, of a specific tensor 1042 to be loaded into an accelerator memory. In this case, an accelerator memory manager may load the specific tensor 1042 stored in the first area 342 directly into the accelerator memory even without going through a memory controller. In other embodiments, a translation table of the physical address 1032 and a logical address for the first area 342 of the specific tensor 1042 may be stored in a storage accessible to the accelerator memory manager. In this case, the accelerator memory manager may receive a tensor read request including the logical address of the tensor, may translate the logical address into the physical address for the first area 342 based on the translation table, and may load the specific tensor 1042 stored in the first area 342 directly into the accelerator memory even without going through the memory controller by using the translated physical address. In the embodiment illustrated in FIG. 10B, the accelerator memory manager may be allowed to access the first area 342.

The accelerator memory manager may store the specific tensor 1022 and 1042 loaded from the first area 342 back into the second area. For example, the accelerator memory manager may store the specific tensor 1022 and 1042 into the second area and assign a tensor ID to the specific tensor 1022 and 1042. Corresponding information on a physical address of the second area where the specific tensor 1022 and 1042 is stored and the tensor ID assigned to the specific tensor 1022 and 1042 may be stored in a third table, e.g., the third table 820 in FIG. 8. Accordingly, it may then be possible for the accelerator memory manager to load the specific tensor 1022 and 1042 into the accelerator memory using only the tensor ID.

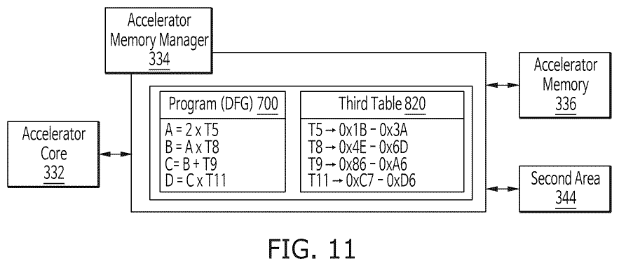

FIG. 11 illustrates an example of how the accelerator memory manager 334 performs a tensor operation according to one or more embodiments of the present disclosure. The accelerator memory manager 334 may obtain the data flow graph 700 of a corresponding program to be executed in response to receiving a program execution request, e.g., the program execution request 640 in FIG. 6B. The data flow graph 700 may be stored in a storage accessible to the accelerator memory manager 334. In other embodiments, the data flow graph 700 may be stored within the accelerator memory manager 334 in advance of the registration of a corresponding program.

In one or more embodiments, when a program that requires parameter data, e.g., additional data needed for the execution of the program at the time of the execution of the program, is to be executed, the accelerator memory manager 334 may build a complete data flow graph 700 that includes the parameter data at the time of the execution of the program.

The accelerator memory manager 334 may select a target node from a plurality of nodes included in the data flow graph 700 and load a tensor of at least one node that is dependent on the target node from the second area 344. For example, the accelerator memory manager 334 may identify a tensor ID of the tensor to be loaded based on the data flow graph 700. In addition, the accelerator memory manager 334 may identify a physical address of the tensor corresponding to the identified tensor ID by referring to the third table 820. Thereafter, the accelerator memory manager 334 may load the tensor stored at the identified physical address from the second area 344 into the accelerator core 332 and/or the accelerator memory 336.

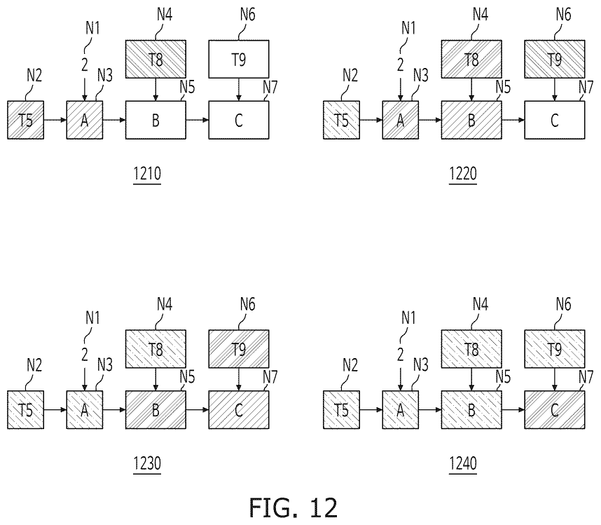

The accelerator memory manager 334 may sequentially perform tensor operation requests in connection with kernels of the data flow graph 700. Accordingly, while the accelerator core 332 carries out a tensor operation request for a specific kernel, the accelerator memory manager 334 may perform prefetch to preload a tensor of a node of a subsequent kernel. An example of how the prefetch is performed will be described in detail with reference to FIG. 12.

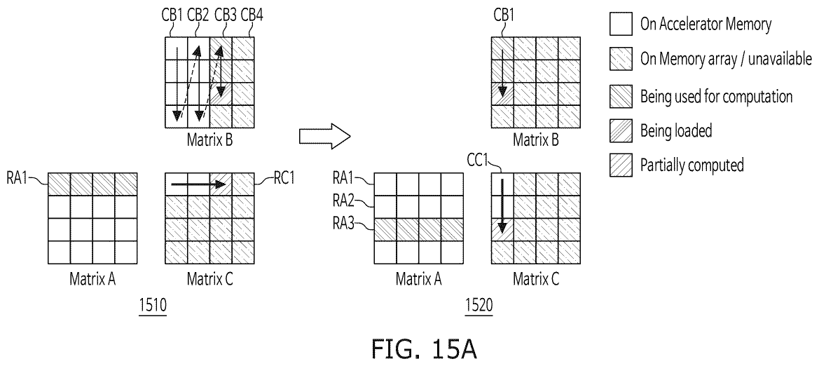

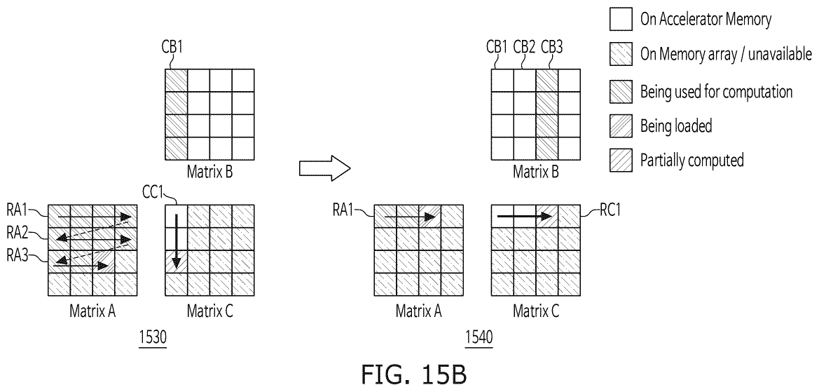

In other embodiments, the accelerator core may carry out tiling to divide tensors required for operations into tile units and perform tensor operation requests tile-by-tile. An example of how the tiling is performed will be described in detail with reference to FIGS. 15 to 18.

As such, the accelerator memory manager may perform the prefetch based on the data flow graph, thereby minimizing the time delay in the process of loading tensors from the memory array and efficiently carrying out high-bandwidth computational tasks.

FIG. 12 shows an example of how prefetching is performed according to one or more embodiments of the present disclosure. FIG. 12 illustrates a specific example of the process of performing prefetching.

A first example 1210 is an example of how a tensor operation (A=2×T5) is performed on the first node N1 and the second node N2. Here, a first tensor 2 in connection with the first node N1 may be data included in a program itself or parameter data required for the execution of the program at the time of the execution of the program, but the present disclosure is not limited thereto. A second tensor T5 in connection with the second node N2 may be fully loaded into the accelerator core before the tensor operation on the first node N1 and the second node N2 is performed. The accelerator core may perform the tensor operation on the first node N1 and the second node N2 to generate a third tensor A in connection with the third node N3. While the accelerator core performs the tensor operation on the first node N1 and the second node N2, the accelerator memory manager may carry out prefetching on a fourth tensor T8 in connection with a fourth node N4 that is dependent on the third node N3.

A second example 1220 is an example of how a tensor operation on the third node N3 and the fourth node N4 is performed after the tensor operation on the first node N1 and the second node N2 of the first example 1210 has been completed and the fourth tensor T8 of the fourth node N4 has been completely loaded. The accelerator core may perform the tensor operation on the third node N3 and the fourth node N4 to generate a fifth tensor B of a fifth node N5. While the accelerator core performs the tensor operation on the third node N3 and the fourth node N4, the accelerator memory manager may carry out prefetching on a sixth tensor T9 in connection with a sixth node N6 that is dependent on the fifth node N5. In addition, after the tensor operation on the third node N3 has been completed, the third tensor A of the third node N3 may be stored in the second area in response to a tensor save request. In other embodiments, after the tensor operation on the third node N3 has been completed, the third tensor A of the third node N3 may be stored in the accelerator memory, not in the second area.

A third example 1230 is an example of how a tensor operation on the fifth node N5 and the sixth node N6 is performed after the tensor operation on the third node N3 and the fourth node N4 of the second example 1220 has been completed and the sixth tensor T9 of the sixth node N6 has been completely loaded. The accelerator core may perform the tensor operation on the fifth node N5 and the sixth node N6 to generate a seventh tensor C of a seventh node N7.

A fourth example 1240 is an example of a tensor operation on the final node, the seventh node N7, which has been completed. When the seventh tensor C of the seventh node N7 is a final value of the execution of a program, the tensor may be transmitted to a host processor, e.g., the host processor 110 in FIG. 5, through a second interface block, e.g., the second interface block 314 in FIG. 5. On the other hand, when the seventh tensor C is an intermediate value, the tensor may be stored in the second area or in the accelerator memory.

Although FIG. 12 shows an example of double-buffering, where a tensor for a single kernel is prefetched so that a tensor required for a kernel that is currently performing an operation and a tensor required for the next kernel exist in the accelerator memory, the present disclosure is not limited thereto. For example, two or more kernels may be preloaded or prefetched into the accelerator memory.

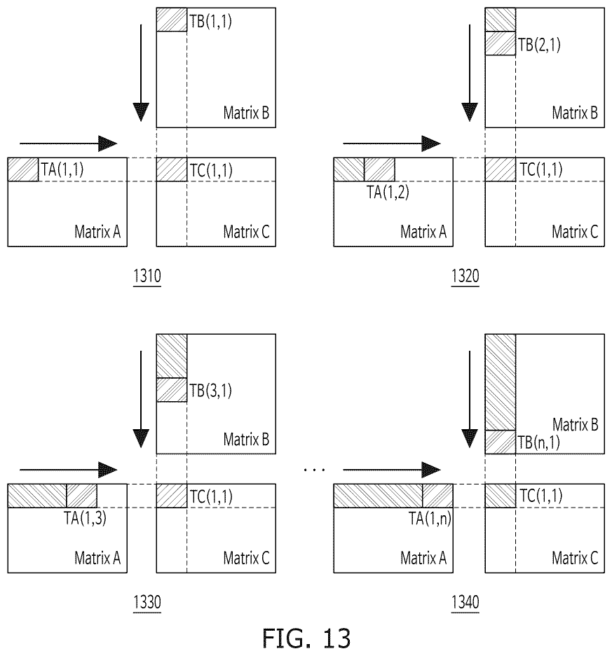

FIG. 13 shows an example of how tiling is performed according to one or more embodiments of the present disclosure. FIG. 13 illustrates the process of performing tensor operations on tensors as matrix data. For example, the tensor operations may be a matrix multiplication operation.

In one or more embodiments, a tensor may be divided into tile units. Here, a tile may refer to a unit in which a tensor as matrix data is divided into rectangular micro-matrices. The size of a tile may correspond to the size, e.g., 4 KB to 16 KB, of a page, which is the minimum unit for reading data from a memory array. In other embodiments, the size of a tile may correspond to a multiple of the size of a page.

FIG. 13 shows the process of performing a matrix multiplication operation between tensor A (hereinafter, referred to as “matrix A”) as matrix data and tensor B (hereinafter, referred to as “matrix B) as matrix data. Referring to examples 1 to 4 1310 to 1340, in order to perform a matrix multiplication operation on a first tile TC(1,1) of matrix C, operations must be performed sequentially on each of all tiles in the first horizontal line (row) of matrix A and all tiles in the first vertical line (column) of matrix B.

Referring to the first example 1310, at the time of starting the operation on the tile TC(1,1) of matrix C, a tile TA(1,1) of matrix A and a tile TB(1,1) of matrix B may have been fully loaded into the accelerator core. Referring to the second example 1320, while an operation is performed on the tile TA(1,1) of matrix A and the tile TB(1,1) of matrix B, the accelerator memory manager may load a tile TA(1,2) of matrix A and a tile TB(2,1) of matrix B from the memory array to the accelerator core. Referring to the third example 1330, while an operation is performed on the tile TA(1,2) of matrix A and the tile TB(2,1) of matrix B, the accelerator memory manager may load a tile TA(1,3) of matrix A and a tile TB(3,1) of matrix B from the memory array to the accelerator core. Referring to the fourth example 1340, when an operation has been completed on a tile TA(1,n) of matrix A and a tile TB(n,1) of matrix B, the matrix multiplication operation on the first tile TC(1,1) of matrix C may be completed.

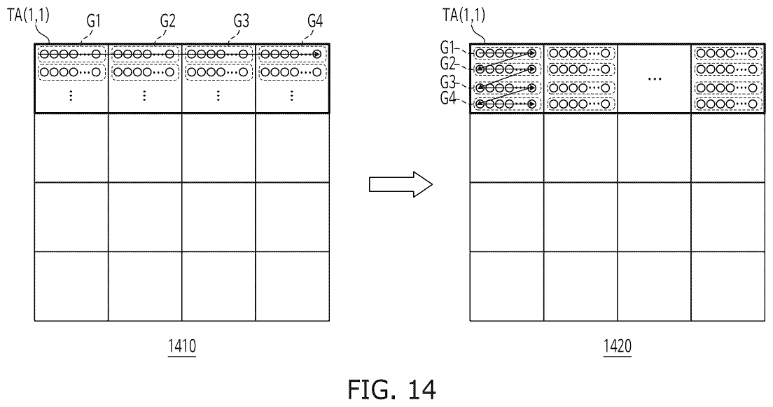

As a result, the tensor operation process may be optimized by tiling, so that high-bandwidth operations by the accelerator may be effectively supported. Accordingly, it may be possible to overcome the gap caused by the difference between the speed at which the memory array transmits data and the speed at which the accelerator processes data. To perform tiling, the order in which data is loaded may be changed to allow efficient access to tiles while matrix multiplication operations are performed tile-by-tile. An example thereof will be described below with reference to FIG. 14.

FIG. 14 illustrates an example of how a tensor save request for performing a tile-based operation is carried out according to one or more embodiments of the present disclosure. When performing a tile-based operation, data may be loaded in tensor units for efficient access to tiles.

A first example 1410 is an example of how a tensor save request is performed on a row-by-row basis rather than tile-by-tile. Referring to the first example 1410, data may be stored sequentially on a row-by-row basis in a tensor. For example, data units, such as G1 to G4, that can be read or written from a memory array may be stored in one row. In this case, it may be necessary to load all data in multiple rows in order to perform an operation on the tile TA(1,1).

A second example 1420 is an example of how a tensor save request is performed tile-by-tile. Referring to the second example 1420, data may be stored sequentially tile-by-tile in a tensor. For example, data units G1 to G4 that can be read or written from a memory array may be stored in one tile. In this case, it may be possible to perform an operation on the tile TA(1,1) by loading only the data contained in the tile TA(1,1).

FIGS. 15A and 15B show examples of how tensor operation requests are performed tile-by-tile according to one or more embodiments of the present disclosure.

FIG. 15A shows an example of a matrix multiplication operation between matrix A fully loaded into an accelerator memory and matrix B being loaded from a memory array. In this case, matrix A has been stored in the accelerator memory, so it may be loaded into an accelerator core before matrix B.

Referring to FIG. 15A, matrix A may be a left matrix for a matrix multiplication operation while matrix B may be a right matrix therefor. As in a first example 1510, when a matrix multiplication operation is performed on a row-first basis so that an operation on a first row RC1 of matrix C is carried out first, first to fourth columns CB1 to CB4 of matrix B must all be loaded from a memory array, which may be inefficient. In contrast, as in a second example 1520, when a matrix multiplication operation is performed on a column-first basis so that an operation on a first column CC1 of matrix C is carried out first, it may be efficient because the operation can be performed only with the first column CB1 of matrix B loaded from the memory array. Therefore, when a left matrix for a matrix multiplication operation has been fully loaded into an accelerator memory and a right matrix therefor is being loaded from a memory array into the accelerator memory, the matrix multiplication operation may be performed column-first.

FIG. 15B shows an example of a matrix multiplication operation between matrix A being loaded from a memory array and matrix B fully loaded into an accelerator memory. In this case, matrix B has been stored in the accelerator memory, so it may be loaded into an accelerator core before matrix A.

Referring to FIG. 15B, matrix A may be a left matrix for a matrix multiplication operation while matrix B may be a right matrix therefor. As in a third example 1530, when a matrix multiplication operation is performed column-first so that an operation on the first row RC1 of matrix C is carried out first, it may be inefficient because first to fourth rows RA1 to RA4 of matrix A must all be loaded from a memory array. In contrast, as in a fourth example 1540, when a matrix multiplication operation is performed on a row-first basis so that an operation on the first row RC1 of matrix C is carried out first, it may be efficient because the operation can be performed only with the first row RA1 of matrix A loaded from the memory array. Therefore, when a right matrix for a matrix multiplication operation has been fully loaded into an accelerator memory and a left matrix therefor is being loaded from a memory array into the accelerator memory, the matrix multiplication operation may be performed on a row-first basis.

As such, an optimized operation order may be adopted based on whether a matrix for performing a matrix multiplication operation has been loaded into an accelerator memory or is being loaded from a memory array, thereby carrying out the operation more efficiently.

It would be apparent to a person having ordinary skill in the art that the structure of the present disclosure can be modified or changed in various ways within the scope or technology of the present disclosure. When any modification and variation to the present disclosure are deemed to fall within the scope of the claims below and their equivalents in view of the foregoing, the present disclosure is deemed to include such modification and variation.

As such, the example embodiments have been disclosed in the drawings and specification. Although specific terms have been used to describe the embodiments in this specification, they have been used only for the purpose of describing the technology of the present disclosure and are not intended to limit the meaning or the scope of the present disclosure set forth in the claims. Therefore, a person having ordinary skill in the art would understand that various modifications can be made to the present disclosure and equivalent other embodiments can be derived therefrom. Accordingly, the true technical protection scope of the present disclosure should be determined based on the technology set forth in the appended claims.

What is claimed is:

1. A computational storage device comprising:
a memory array comprising:
a first area; and
a second area;
a memory controller configured to access the first area and have limited access to the second area;
a hardware accelerator configured to access the second area;
a first interface block configured to connect the memory controller to a host processor; and
a second interface block configured to connect the hardware accelerator to the host processor,
wherein the memory controller is further configured to perform a first type of request of the host processor, for data of the first area, and
wherein the hardware accelerator is configured to perform a second type of request in connection with a tensor of the host processor, for data of the second area.

2. The computational storage device as claimed in claim 1, wherein the first type of request comprises at least one of a data read request and a data write request for the first area, which the memory controller is configured to perform, and
wherein the second type of request comprises at least one of a tensor read request, a tensor operation request, and a tensor write request, which the hardware accelerator is configured to perform.

3. The computational storage device as claimed in claim 1, wherein the second type of request comprises at least one of a request for registration of a program using the second area and a request for execution of the program,
wherein the program comprises a data flow graph (DFG), and
wherein the data flow graph comprises tensor read requests, tensor save requests for nodes, and tensor operation requests for kernels.

4. The computational storage device as claimed in claim 3, wherein the second interface block is configured to:
assign a program identifier (ID) to the program based on receiving the request for registration of the program from the host processor; and
return the assigned program ID to the host processor.

5. The computational storage device as claimed in claim 4, wherein a storage accessible to the second interface block is configured to store a first table comprising corresponding information on the program and the program ID.

6. The computational storage device as claimed in claim 4, wherein the second interface block is further configured to:
assign a request ID to the request for the execution of the program comprising the program ID based on receiving the request for the execution of the program from the host processor; and
transmit the program associated with the program ID to the hardware accelerator, and
wherein the hardware accelerator is further configured to carry out the request for the execution of the program based on the data flow graph of the program.

7. The computational storage device as claimed in claim 6, wherein a storage accessible to the second interface block is configured to store a second table comprising corresponding information on the request for the execution of the program, the request ID, and status information on the request for the execution of the program,
wherein the status information is to be updated as the request for the execution of the program is completed, and
wherein the second interface block is further configured to return the request ID and a result of the hardware accelerator's performing of the request for the execution of the program to the host processor.

8. The computational storage device as claimed in claim 3, wherein the hardware accelerator comprises:
an accelerator memory manager configured to perform the tensor read requests and the tensor save requests for the nodes;
an accelerator core configured to perform the tensor operation requests for the kernels; and
an accelerator memory configured to store at least one tensor for the accelerator core to perform a tensor operation,
wherein the memory array is a non-volatile memory, and
wherein the accelerator memory is a volatile memory.

9. The computational storage device as claimed in claim 8, wherein, based on receiving a tensor save request of a specific tensor, the accelerator memory manager is configured to:
store the specific tensor in the second area;
assign a tensor identifier (ID) to the specific tensor; and
store, in a table, corresponding information on the assigned tensor ID and a physical address of the second area where the specific tensor is stored.

10. The computational storage device as claimed in claim 9, wherein the accelerator memory manager is further configured to load the specific tensor stored in the second area into the accelerator memory based on receiving a tensor read request comprising the tensor ID.

11. The computational storage device as claimed in claim 8, wherein, based on receiving a tensor read request of a specific tensor stored in the first area, the accelerator memory manager is configured to:
load the specific tensor from the first area;
store the specific tensor in the second area;
assign a tensor ID to the specific tensor;
store, in a table, corresponding information on the assigned tensor ID and a physical address of the second area where the specific tensor is stored; and
load the tensor into the accelerator memory.

12. The computational storage device as claimed in claim 8, wherein the accelerator memory manager is further configured to:
select a first node of a first tensor among a plurality of nodes in the data flow graph as a target node; and
load a second tensor of a second node that is dependent on the first node from the second area into the accelerator memory through a tensor read request, and
wherein the accelerator core is further configured to perform the tensor operation on the first node and the second node to generate a third tensor of a third node.

13. The computational storage device as claimed in claim 12, wherein the accelerator memory manager is further configured to:
load a fourth tensor of a fourth node that is dependent on the third node from the second area to the accelerator memory through the tensor read request while the accelerator core performs the tensor operation on the first node and the second node.

14. The computational storage device as claimed in claim 12, wherein the accelerator core is further configured to divide the first tensor and the second tensor tile-by-tile and perform a tensor operation tile-by-tile, and
wherein a tile has a size that is a multiple of a size of a page, which is a minimum unit for reading data from the memory array.

15. The computational storage device as claimed in claim 14, wherein the first tensor is a left matrix of a matrix multiplication operation and the second tensor is a right matrix of the matrix multiplication operation, and
wherein the accelerator core is further configured to perform the matrix multiplication operation column-first when the first tensor has been loaded into the accelerator memory and the second tensor is being loaded from the second area into the accelerator memory.

16. The computational storage device as claimed in claim 14, wherein the second tensor is a left matrix of a matrix multiplication operation and the first tensor is a right matrix of the matrix multiplication operation, and
wherein the accelerator core is further configured to perform the matrix multiplication operation on a row-first basis when the first tensor has been loaded into the accelerator memory and the second tensor is being loaded from the second area into the accelerator memory.

17. The computational storage device as claimed in claim 1, wherein the memory controller, the hardware accelerator, the memory array, the first interface block, and the second interface block are configured to communicate based on a first protocol, and
wherein the first interface block and the second interface block are configured to communicate with the host processor based on a second protocol different from the first protocol.

18. The computational storage device as claimed in claim 17, wherein the first protocol is an advanced extensible interface (AXI) protocol, and the second protocol is a peripheral component interconnect (PCI)-express protocol.

19. A computational storage system comprising:
a host processor;
a host memory operatively connected to the host processor; and
a computational storage device configured to communicate with the host processor and generate output at a request of the host processor, wherein the computational storage device comprises:
a memory array comprising:
a first area; and
a second area;
a memory controller configured to access the first area and have limited access to the second area;
a hardware accelerator configured to access the second area;
a first interface block configured to connect the memory controller to the host processor; and
a second interface block configured to connect the hardware accelerator to the host processor,
wherein the memory controller is further configured to perform a first type of request of the host processor for data of the first area, and
wherein the hardware accelerator is configured to perform a second type of request in connection with a tensor of the host processor for data of the second area.

20. A computational storage device comprising:
a memory array comprising:
a first area; and
a second area;
a memory controller configured to access the first area;
a hardware accelerator configured to access the second area;
a first interface block configured to connect the memory controller to a host processor; and
a second interface block configured to connect the hardware accelerator to the host processor,
wherein the memory controller is configured to perform a first type of request of the host processor for data of the first area,
wherein the hardware accelerator is configured to perform a second type of request in connection with a tensor of the host processor for data of the second area,
wherein the first type of request comprises at least one of a user data read request and a user data write request for the first area, which the memory controller is configured to perform,
wherein the second type of request comprises at least one of a request for registration of a program and a request for execution of the program for data of the second area,
wherein the program comprises a data flow graph comprising at least one of a tensor read request, a tensor write request, and a tensor operation request for kernels,
wherein the memory controller, the hardware accelerator, the memory array, the first interface block, and the second interface block are configured to communicate based on a first protocol, and
wherein the first interface block and the second interface block are configured to communicate with the host processor based on a second protocol different from the first protocol.
